(19) United States
(12) Patent Application Publication
(10) Pub. No.: US 2016/0372965 A1
(43) Pub. Date: Dec. 22, 2016

(54) SCREENS FOR ELECTRONIC DEVICES, AND METHODS FOR THEIR PREPARATION AND USE

(71) Applicant: EMPIRE TECHNOLOGY DEVELOPMENT LLC, Wilmington, DE (US)

(72) Inventor: Christopher J. ROTHFUSS, Laramie, WY (US)

(73) Assignee: EMPIRE TECHNOLOGY DEVELOPMENT LLC, Wilmington, DE (US)

(21) Appl. No.: 15/120,751

(22) PCT Filed: Mar. 4, 2014
(86) PCT No.: PCT/US14/20240

§ 371 Date: Aug. 23, 2016

(51) Int. Cl. H02J 7/35; H02S 40/32; H02S 40/38

(52) U.S. Cl. CPC H02J 7/355; H02S 40/38; H02S 40/32

(57) ABSTRACT

A screen for an electronic device can include an intrascreen array of thin film photovoltaic cells embedded into a screen layer. The photovoltaic cells can be disposed at least substantially normal to a surface plane of the screen layer. The photovoltaic cells can thus be configured to capture light that is at least substantially off-normal to the surface plane of the screen layer.

### BACKGROUND

Mobile electronic devices such as smartphones, electronic book readers, and tablets have become popular in the international marketplace. In general, these mobile electronic devices are powered by batteries. Due to the multitude of functions and operational requirements that these mobile electronic devices possess, the power demands of these mobile electronic devices have increased, leading to shorter operating periods of the batteries. Therefore, it is generally desirable to extend the operating periods of batteries in mobile electronic devices.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

In some embodiments, a screen for an electronic device can comprise a first array of thin film photovoltaic cells at least partially embedded in a screen layer, wherein the thin film photovoltaic cells are disposed at least substantially normal to a surface plane of the screen layer to capture light that is at least substantially off-normal to the surface plane of the screen layer.

In some embodiments, an electronic device can comprise a screen layer; a first array of thin film photovoltaic cells at least partially embedded in the screen layer, wherein the thin film photovoltaic cells are disposed at least substantially normal to a surface plane of the screen layer to capture light that is at least substantially off-normal to the surface plane of the screen layer; and electronic interfaces coupled to the thin film photovoltaic cells, wherein the electronic interfaces are configured to collect electricity produced by the thin film photovoltaic cells.

In some embodiments, a method of making a screen for an electronic device, wherein the screen defines a surface plane, can comprise positioning a first array of thin film photovoltaic cells relative to the surface plane, wherein at least some of the photovoltaic cells are positioned substantially normal to the surface lane, and wherein at least some of the photovoltaic cells are configured to capture light that is off-normal to the surface plane.

In some embodiments, a method of using an electronic device can comprise providing an electronic device. The electronic device can comprise a screen layer; a first array of thin film photovoltaic cells at least partially embedded in the screen layer, wherein the thin film photovoltaic cells are disposed at least substantially normal to a surface plane of the screen layer to capture light that is at least substantially off-normal to the surface plane of the screen layer; and electronic interfaces coupled to the thin film photovoltaic cells, wherein the electronic interfaces are configured to collect electricity produced by the thin film photovoltaic cells. In sonic embodiments, the method of using an electronic device can further comprise exposing the thin film photovoltaic cells to light, thereby causing the thin film photovoltaic cells to produce electricity and causing the electronic interfaces to collect the electricity produced by the thin film photovoltaic cells.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a side cross sectional view of an array of photovoltaic cells at least partially embedded in a screen layer of an electronic device according to a disclosed embodiment.

FIG 2a illustrates a top view of the embodiment illustrated in FIG. 1.

FIG. 2b illustrates a close up view of one section of the embodiment illustrated in FIG. 2a.

FIG. 3 illustrates a photovoltaic cell with a light-capturing side and a non light capturing side according to a disclosed embodiment.

FIG. 4 illustrates a photovoltaic cell unit having two light capturing sides according to a disclosed embodiment.

FIG. 5 illustrates a top view of an electronic device with two arrays of photovoltaic cells embedded in a screen layer of an electronic device according to a disclosed embodiment.

FIG. 6 illustrates a method of making a screen having an array of photovoltaic cells embedded in a screen layer of an electronic device according to a disclosed embodiment.

### DETAILED DESCRIPTION

Photovoltaic cells, such as thin film photovoltaic cells, may be used to extend the battery life of electronic devices, such as mobile electronic devices (for example, smartphones, tablets, electronic book readers). Light that is incident on the photovoltaic cells may be absorbed by the photovoltaic cells and converted to electrical power to charge the electronic device For example, an external photovoltaic charger may be used to charge a battery within an electronic device. As another example, a solar panel may be placed on top of within, or beneath a screen of an electronic device, such that the light capturing side of the solar panel is disposed parallel to a surface plane of the screen. These types of solar panels produce power most effectively when incident light is normal to the screen. When incident light is off-normal to the screen, the power produced by these types of solar panels is considerably less because the normal component of the light incident on the solar panel is smaller. Thus, in order to most effectively charge an electronic device, these types of solar panels should be pointed at a light source in order to maximize the normal component of the light, in addition, these types of solar panels may interfere with the optical output of the electronic device. For example, optical losses, tinting, or shading of the screen may interfere with the optical output of the electronic device.

In contrast, the embodiments disclosed herein include at least one array of thin film photovoltaic cells at least partially embedded in a screen layer of an electronic device. In addition, the array of thin film photovoltaic cells may be disposed normal to a surface plane of the screen layer. Thus, the array of thin film photovoltaic cells may be configured to capture light that is substantially off-normal to a surface plane of the screen layer. Accordingly, the array of thin film photovoltaic cells according to some embodiments can produce electricity effectively at a variety of different angles and physical orientations. The electronic device need not be pointed directly at a light source in order to effectively charge the electronic device. Further, in some embodiments, the array of thin film photovoltaic cells does not significantly impair the image quality of the electronic device. In addition, the array of thin film photovoltaic cells according to some embodiments may increase display efficiency. For example, when light is projected from the screen to the user, projected light that is off normal to a surface plane of the screen layer may be absorbed by the photovoltaic cells and converted to electrical power. Projected light that is normal to the surface plane of the screen layer may pass to the user for viewing the electronic device. Further, the array of thin film photovoltaic cells may provide privacy to a user of the electronic device. For example, the image displayed on the screen may be obscured when viewed at an angle, while the image displayed on the screen may be seen clearly when the user's line of vision is normal to the surface plane of the screen layer. In some embodiments, the electronic device may be a mobile electronic device, such as a smartphone, tablet, electronic book reader, or other mobile electronic device.

In some embodiments, the width of individual photovoltaic cells may be sufficiently small such that they do not significantly interfere with light projected from the display. Thus, the majority of light projected outward from the display may be unimpeded by the array of photovoltaic cells embedded in the screen. In addition, the width of individual photovoltaic cells may be sufficiently small such that they are nearly invisible to a user. Therefore, a large number of photovoltaic cells may be used in the array, and each of the cells may be placed in close proximity to one another, without significantly impairing the image quality. In addition, in some embodiments, transparent photovoltaic cells may be used in the array. Thus, the image projected to the user may be clear and free of visible interference.

In some embodiments, the array of photovoltaic cells may function as a collimator, such that the array of photovoltaic cells may allow light that is projected at least substantially normal to the screen layer to pass through, while absorbing light that is projected at least substantially off-normal to the screen. The absorbed light may be converted to electrical power. Thus, the array of photovoltaic cells can recycle excess light from the display, thereby increasing efficiency.

In addition, because the photovoltaic cells may be disposed substantially normal to the surface of the screen, the image displayed may be seen clearly when the user's line of vision is also substantially normal to the screen. On the other hand, when the screen is viewed at an angle, the image may be obscured due to shading. Thus, the array of photovoltaic cells may function to provide privacy to a user.

Accordingly, in some embodiments, a screen for an electronic device may include a first array of thin film photovoltaic cells at least partially embedded in a screen layer, wherein the thin film photovoltaic cells are disposed at least substantially normal to a surface plane of the screen layer to capture light that is at least substantially off-normal to the surface plane of the screen layer. In some embodiments, the screen may further include a second array of thin film photovoltaic cells at least partially embedded in the screen layer, wherein the thin film photovoltaic cells of the second array are disposed at least substantially normal to the surface plane of the screen layer to capture light that is substantially off-normal to the surface plane of the screen layer, and wherein the thin film photovoltaic cells of the second array are disposed at least substantially perpendicular to the thin film photovoltaic cells of the first array.

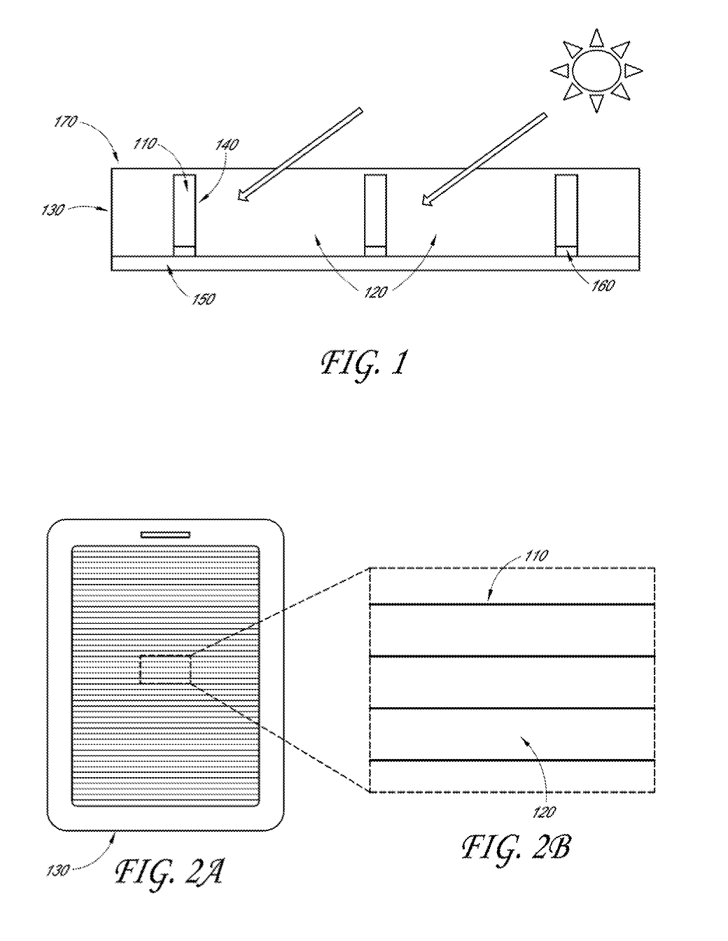

FIG. 1 illustrates an exemplary configuration of thin film photovoltaic cells 110 at least partially embedded in a screen layer 120 of an electronic device 130 according to one embodiment. In particular, FIG. 1 illustrates a side cross sectional view of an array of thin film photovoltaic cells 110 at least partially embedded into the screen layer 120 of an electronic device 130. The electronic device may be a mobile electronic device, such as a smartphone, tablet, electronic book reader, or other mobile electronic devices. In some embodiments, the material of the screen layer includes glass such as borosilicate glass, high-strength transparent polymers such as polycarbonate, transparent alumina such as sapphire, or a combination thereof FIG. 2a illustrates a top view of the thin film photovoltaic cells illustrated in FIG. 1. FIG. 2b illustrates a close up view of one section of FIG. 2a.

Referring to FIG. 1, the light capturing sides 140 of the thin film photovoltaic cells 110 may be disposed at least substantially normal to a surface plane 170 of the screen layer 120. Thus, referring to FIG. 2, only the edges of the photovoltaic cells 110 are visible when the array of photovoltaic cells 110 is viewed from the top of the electronic device 130. In some embodiments, the thickness of the photovoltaic cells 110 is sufficiently small such that they are hardly noticeable to a user. Returning to FIG. 1, because the photovoltaic cells 110 may be disposed at least substantially normal to the surface plane 170 of the screen layer 120, the photovoltaic cells 110 may be configured to capture light that is at least substantially off-normal to the surface plane of the screen layer 120. Therefore, the electronic device 130 can be charged using light that is incident on the photovoltaic cells 110 at a wide range of angles. In some embodiments, the photovoltaic cells 110 need not be perfectly normal to the surface plane 170 of the screen layer 120. For example, it may be beneficial to dispose the photovoltaic cells 110 slightly off-normal to the surface plane 170 of the screen layer 120 at the edges of the screen.

Still referring to FIG. 1, the array of photovoltaic cells 110 may be configured to capture ambient light, including the solar spectrum of light, artificial light, or a combination thereof. The array of photovoltaic cells 110 may also be configured to capture diffused light emitted by the electronic device, for example, from the display 150 of the electronic device 130. The captured light may then be converted to electrical power to power the electronic device 130, and therefore extend the operating period of the electronic device 130 before a charging of the battery is needed. In some embodiments, the array of photovoltaic cells 110 may be used in conjunction with other photovoltaic chargers to further increase the operating period of the electronic device 130. For example, the array of photovoltaic cells 110 may be used with external solar chargers. As another example, the array of photovoltaic cells 110 may be used in conjunction with solar panels installed above or beneath the array 110. Thus, the solar panel can capture light that is normal to the screen while the array of photovoltaic cells 110 can capture light that is at least substantially off-normal to the screen.

Referring to FIG. 1, the array of photovoltaic cells 110 may be at least partially embedded in a screen layer 120 of an electronic device 130. In some embodiments, the photovoltaic cells 110 do not protrude above the top surface of the screen layer, as illustrated in FIG. 1. In some embodiments, the photovoltaic cells 110 may protrude from the underside of the screen layer. Thus, the photovoltaic cells 110 may be partially embedded in the screen layer in some embodiments. In other embodiments, the photovoltaic cells 110 do not protrude from the screen layer, and thus, may be completely embedded in the screen layer. Further, as illustrated in FIGS. 1-2a, the photovoltaic cells 110 may be disposed parallel to one another in the screen layer 120. Also as illustrated in FIGS. 1-2a, in some embodiments, the photovoltaic cells 110 may be disposed at a constant pitch in the screen layer 120.

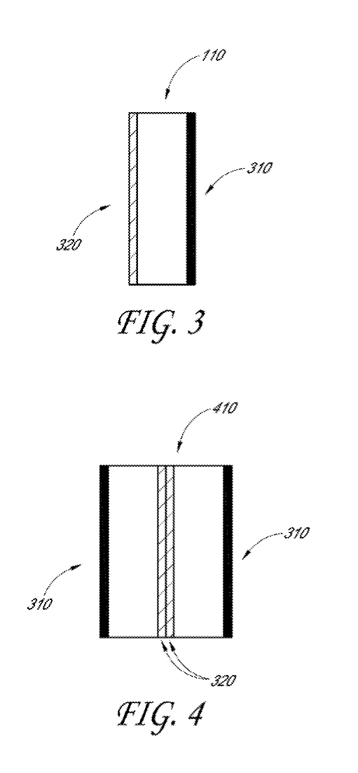

Referring to FIG. 3, in some embodiments, the photovoltaic cells 110 may have a light capturing side 310 and a non-light capturing side 320. The light capturing side 310 may be configured to capture light, while the non-light capturing side 320 may not capture light. Referring to FIG. 4, there is illustrated a pair of two photovoltaic cells 110, with the non-light capturing sides 320 of both photovoltaic cells 110 engaging each other, and the light capturing sides 310 facing away from the non-light capturing sides 320. In this manner, a double-sided photovoltaic cell unit 410 can be formed. The double-sided photovoltaic cell unit 410 can be configured to capture light from both sides of the photovoltaic cell unit 410. In some embodiments, the array of photovoltaic cells 110 includes at least one double-sided photovoltaic cell unit 410. By using a double-sided photovoltaic cell unit 410, the total surface area available to capture light can be increased, thus increasing the amount of power that may be produced by the array 110. Compared to a single sided photovoltaic cell, a double-sided photovoltaic cell unit 410 can also provide a wider range of available angles at which light may be incident on the photovoltaic cells and converted into electrical power.

In some embodiments, the photovoltaic cells may be opaque 110 to visible light, in other embodiments, the photovoltaic cells 110 may be transparent to visible light. Similar to the double-sided photovoltaic cell unit 410 illustrated in FIG. 4, both sides of a transparent photovoltaic cell 110 may be capable of capturing light. Further, in embodiments which include transparent photovoltaic cells in the array, shading may be reduced or completely absent. Shading may occur when light is incident on a photovoltaic cell and that the photovoltaic cell casts a shadow on a neighboring photovoltaic cell 110. In sonic embodiments, the transparent photovoltaic cells may be transparent to visible light. The material of the transparent photovoltaic cells may include glass, transparent polyethylene terephthalate, or a combination thereof.

In some embodiments, an array of photovoltaic cells includes a combination of photovoltaic cells with different properties. For example, the array of photovoltaic cells 110 may include a combination of single sided opaque photovoltaic cells, transparent photovoltaic cells, and double-sided photovoltaic cell units 410. As another example, an array of photovoltaic cells 110 may include a combination of photovoltaic cells optimized to capture different spectra of light. For instance, an array of photovoltaic cells 110 may include a combination of photovoltaic cells optimized to capture artificial light and photovoltaic cells optimized to capture the solar spectrum. In some embodiments, the array of photovoltaic cells 110 includes alternating opaque and transparent photovoltaic cells to prevent shading.

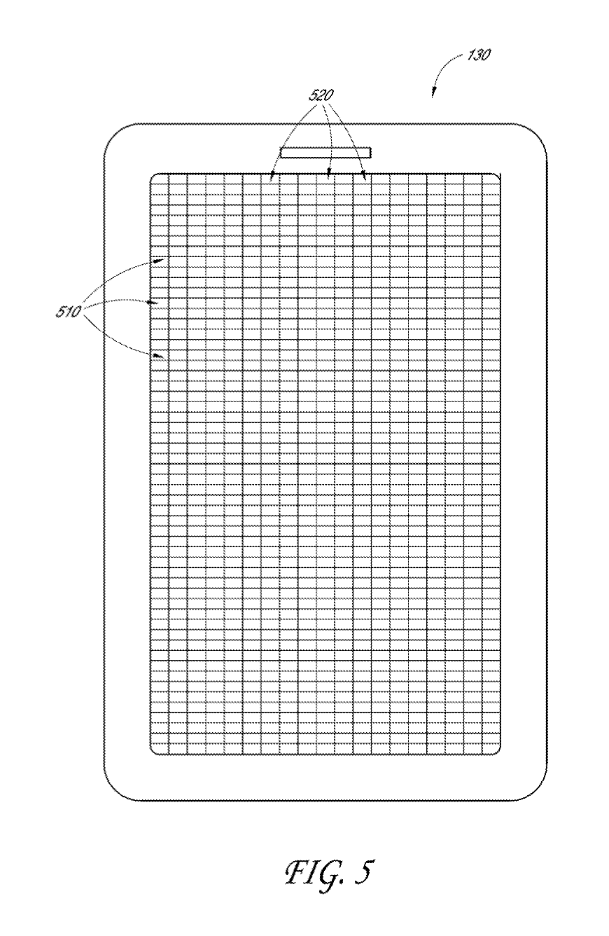

In some embodiments, an electronic device may incorporate the screen as disclosed herein, and electronic interfaces coupled to the thin film photovoltaic cells, wherein the electronic interfaces are configured to collect electricity produced by the thin film photovoltaic cells. FIG. 5 illustrates a top view of an electronic device 130 with two arrays 510, 520 of photovoltaic cells 110 at least partially embedded in the screen layer 120 of an electronic device. In some embodiments, the photovoltaic cells 110 in each of the two arrays 510, 520 are at least partially embedded in the screen layer and disposed at least substantially normal to a surface plane of the screen layer of the electronic device. In addition, as illustrated in FIG. 5, the photovoltaic cells in one array 510 can be disposed at least substantially perpendicular to the photovoltaic cells in another array 520. Thus, as illustrated in FIG. 5, the two arrays 510, 520 of photovoltaic cells can form a cross hatch grid pattern. Compared to a screen having one array of photovoltaic cells in the screen layer, a screen having two arrays 510, 520 of photovoltaic cells in the screen layer may increase the total surface area available to capture light, and hence, the amount of power produced by the photovoltaic cells 110. The screen with the two arrays can also provide a wider range of suitable angles at which light may he incident on the photovoltaic cells 110.

In some embodiments, the thin film photovoltaic cells 110 may have a thickness of about 100 nm to about 100 μm, such as about 100 nm, 200 nm, 300 nm, 400 nm, 500 nm, 600 nm, 700 nm, 800 nm, 900 nm, 1 μm, 10 μm, 20 μm, 30 μm, 40 μm, 50 μm, 60 μm, 70 μm, 80 μm, 90 μm, 100 μm, or a thickness in between any of these values. The material(s) of the photovoltaic cells 110 may include amorphous silicon, gallium arsenide, copper indium gallium diselenide (CIGS), cadmium telluride, organic materials, dye-sensitized materials, poly(3-hexylthiophene), or a combination thereof. In addition, the thin film photovoltaic cells may include thin films of material, which may be fabricated using chemical vapor deposition, chemical bath deposition, casting, spincoating, inkjet printing, slot die coating, electron-beam evaporation, co-evaporation techniques, selenization processes, paste coating techniques (for example, doctor blading, screen printing, curtain coating), chemical spray pyrolysis, electrodeposition, or a combination thereof.

In addition, the photovoltaic cells 110 may include a pair of electrodes. The material(s) of the electrodes may include indium tin oxide, titanium-titanium oxide films, transparent patterned metal grids, eutectic gallium-indium, titanium, aluminum, gold, silver, platinum, copper, graphite, grapheme, reduced grapheme oxide, poly(3,4-ethylenedioxythiophelle):poly(styrenesulfonate), polyacetylene, polyparaphenylene, polypyrrole, polyaniline, or a combination thereof. Further, the photovoltaic cells 110 may include a substrate. The material(s) of the substrate may include metal foils, steel, polymers, polyethylene terephthalate, polyethylene sulphonate, polyethylene naphthalate, liquid crystal polymer, thermoplastic ethylene-tetracyclododecene copolymer, glass, borosilicate glass, soda-lime glass, or a combination thereof In some embodiments, the photovoltaic cells 110 may be lightweight and compact, thus adding negligible size and weight to the electronic device 130.

In some embodiments, any impairment to the image quality on the display 150 of the electronic device 130 caused by the array of photovoltaic cells 110 being at least partially embedded in the screen layer 120, may be negligible. The width of each individual photovoltaic cell 110 may be sufficiently small such that they do not significantly interfere with light projected from the display 150. Thus, the great majority of light projected outward from the display 150 may be unimpeded by the array of photovoltaic cells 110 at least partially embedded in the screen layer 120. In addition, the width of each individual photovoltaic cell 110 may be sufficiently small such that they are hardly visible to a user viewing the display 150 of the electronic device 130. Therefore, a large number of photovoltaic cells 110 may be used in the array, and each of the photovoltaic cells 110 in the array may be placed in close proximity to each other, without significantly impairing the image quality of the electronic device 130. In addition, in some embodiments, transparent photovoltaic cells may be used in the array. The transparent photovoltaic cells may be transparent to visible light. Thus, the image projected to the user from the display 150 may be clear and free from visible interference from the transparent photovoltaic cells.

In some embodiments, the array of photovoltaic cells 110 may function as a collimator. Referring to FIG. 1, because the array of photovoltaic cells 110 may be disposed at least substantially normal to the surface plane 170 of the screen layer, the array of photovoltaic cells may allow light that is projected at least substantially normal to the screen layer to pass through, while absorbing light that is projected at least substantially off-normal to the screen. The absorbed light may be converted to electrical power. Thus, the array of photovoltaic cells 110 can recycle excess light from the display 150, thereby increasing display 150 efficiency.

In addition, because the photovoltaic cells 110 may be disposed at least substantially normal to the surface plane 170 of the screen layer, the image displayed by the display 150 of the electronic device 130 may be seen clearly when the user's line of vision is at least substantially normal to the surface plane 170 of the screen layer 120. When the screen is viewed at an angle, the image displayed on the screen may be obscured due to shading. Thus, advantageously, the array of photovoltaic cells 110 that is at least partially embedded in the screen layer 120 may provide privacy to a user of the electronic device 130. The amount of obscuration of the screen image display may depend on the amount of spacing between each photovoltaic cell 110 in the array. In embodiments which include transparent photovoltaic cells, shading may be reduced or completely absent. Thus, in these embodiments, a user may view the screen image display less obscuration than when the user views the display 150 at an angle.

In operation, the array of photovoltaic cells 110 may capture incident, light. The photovoltaic cells 110 may then convert the captured light to electrical power, which may extend the operating period of the electronic device 130 before a charging of the battery is needed. The electrical power may charge the battery of the electronic device 130, or the electrical power may be directly supplied to the electronic device 130 such that the electrical power is consumed immediately by the device 130, or both.

Referring to FIG. 1, electronic interfaces 160 may be coupled to the photovoltaic cells 110. The electronic interfaces 160 may be configured to collect electricity produced by the photovoltaic cells 110 and transfer the electricity to the electronic device 130. For example, the electronic interfaces 160 may be configured to directly supply the electronic device 130 with the electricity collected from the photovoltaic cells 110, charge a battery of the electronic device 130 with the collected electricity, or both. The electronic interfaces 160 may be designed to match the power produced by the array of photovoltaic cells 110 with the power requirements of the electronic device 130.

The electronic interfaces 160 may include electrical components that link the electrodes of the photovoltaic cells 110 to the circuitry of the electronic device 130, in some embodiments, the electronic interfaces 160 may be disposed between electrodes of the photovoltaic cells 110 and the circuitry of the electronic device. In some embodiments, the electronic interfaces 160 may connect the photovoltaic cells 110 to a power supply of the device 130. As an example, the electronic interfaces 160 may include wires, capacitors, resistors, and other electrical components. The electronic interfaces 160 may also include electrical contacts, which may be disposed beneath the photovoltaic cells 1.10, beneath the screen, on one or more edges of the photovoltaic cells 110, around a rim of the screen, or a combination thereof. The placement of the electrical contacts may be designed based on the configuration and design of the electronic device 130. The material(s) of the electrical contacts may include conductive metals, gold, silver, aluminum, platinum, copper, carbon-based conductors, graphite, graphene, conductive polymers, poly(3,4-ethylenedioxythiophene):poly(styrenesulfonate), polyacetylene, polyparaphenylene, polypyrrole, polyaniline, or a combination thereof.

In some embodiments, the array of photovoltaic cells 110 can extend the battery life of an electronic device 130 by about 5% to about 10% per hour. Further, in some embodiments, the recharge rate for e-book readers may exceed the power consumption rate of e-book readers. Thus, in some embodiments the intrascreen array of photovoltaic cells 110 can power an e-book reader indefinitely.

In some embodiments, the amount of power produced by the array of photovoltaic cells 110 may be proportional to the total surface area of the photovoltaic cells 110. Increasing the number of photovoltaic cells 110 in the array may increase the total potential surface area of the photovoltaic cells 110, and hence, may also potentially increase the total power produced by the array. On the other hand, when the number of photovoltaic cells 110 is increased, the space between each photovoltaic cell 110 in the array may be decreased. Decreasing the space between each photovoltaic cell 110 may increase shading, which reduces the surface area available to capture light, in embodiments which include transparent photovoltaic cells, shading may be reduced or completely absent. Thus, to maximize the power produced by the intrascreen array of photovoltaic cells 110, both the number of photovoltaic cells 110 and the effects of shading may be considered.

In some embodiments, the array of photovoltaic cells 110 may be at least partially embedded into an existing screen that is integrated into an electronic device 130. In other embodiments, the array of photovoltaic cells 110 may be embedded in a secondary screen that is separate and detached from an electronic device 130. The secondary screen may be placed on top of an existing screen integrated with an electronic device, in addition, the secondary screen may be configured to connect to a mobile electronic device 130 through, for example, a power port of the electronic device 130.

In some embodiments, a method of making a screen for an electronic device may include providing a first plurality of thin film photovoltaic cells, at least partially embedding the first plurality of thin film photovoltaic cells in a screen layer, and disposing the first plurality of thin film photovoltaic cells at least substantially normal to a surface plane of the screen layer to capture light that is at least substantially off-normal to the surface plane of the screen layer. In some embodiments, the method may further include providing a second plurality of thin film photovoltaic cells, at least partially embedding the second plurality of thin film photovoltaic cells in the screen layer, disposing the second plurality of thin film photovoltaic cells at least substantially normal to the surface plane of the screen to capture light that is at least substantially off-normal to the surface plane of the screen layer, and disposing the second plurality of thin film photovoltaic cells at least substantially perpendicular to the first plurality of thin film photovoltaic cells.

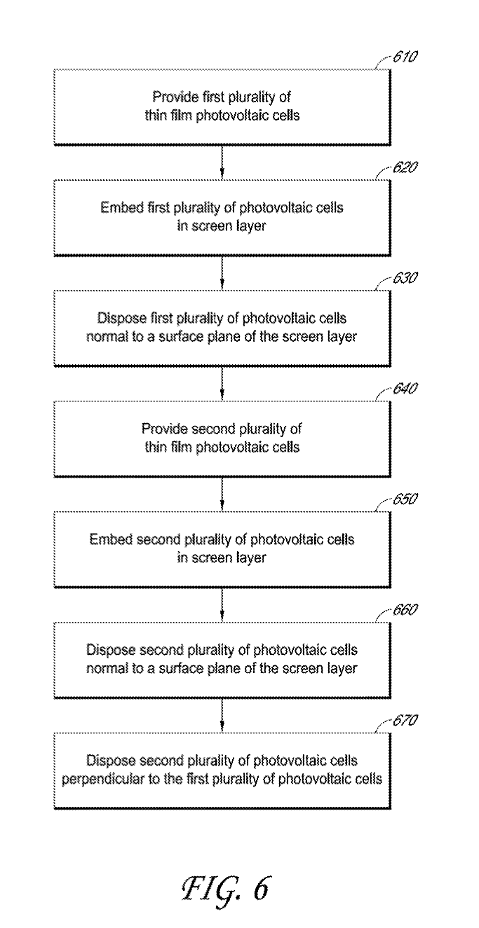

FIG. 6 illustrates one example of a method of making a screen for an electronic device 130. In some embodiments, the electronic device 130 may be a mobile electronic device, such as a smartphone, tablet, electronic book reader, or other mobile electronic device. At step 610, a first plurality of thin film photovoltaic cells 110 may be provided. At step 620, the first plurality of photovoltaic cells 110 may be embedded, at least partially, in a screen layer 120 of the electronic device 130. At step 630, the first plurality of photovoltaic cells 110 may be disposed at least substantially normal to a surface plane 170 of the screen layer 120. These steps need not be executed in a particular order. For example, in some embodiments, step 630, wherein the first plurality of photovoltaic cells are disposed at least substantially normal to a surface plane 170 of the screen layer 120, may be performed before step 620, wherein the first plurality of photovoltaic cells are embedded at least partially in the screen layer 120. As an example, FIG. 1 illustrates a side cross sectional view and FIG. 2a illustrates a top view of photovoltaic cells 110 that are at least partially embedded in a screen in an orientation that is at least substantially normal to the surface plane 170 of the screen layer. Thus, referring to FIG. 1, the photovoltaic cells 110 may be configured to capture light that is off-normal to the surface plane 170 of the screen layer 120 In some embodiments, the photovoltaic cells 110 may be disposed in the screen layer 120 in an array. In addition, the photovoltaic cells 110 may be disposed parallel to one another, as illustrated in FIGS. 1-2a. Further, the photovoltaic cells 110 may be disposed at a constant pitch in the screen layer 120, as also illustrated in FIGS. 1-2a.

Returning to FIG. 6, in some embodiments, a second plurality of thin film photovoltaic cells 110 may be provided at step 640. At step 650, the second plurality of photovoltaic cells 110 may be embedded, at least partially, in the screen layer 120. At step 660, the second plurality of photovoltaic cells 110 may be disposed at least substantially normal to a surface plane 170 of the screen layer 120. These steps need not be executed in a particular order. For example, in some embodiments, step 660, wherein the second plurality of photovoltaic cells are disposed at least substantially normal to a surface plane 170 of the screen layer 120, may be performed before step 650, wherein the second plurality of photovoltaic cells are embedded at least partially in the screen layer 120. At step 670, the second plurality of photovoltaic cells 110 may be disposed at least substantially perpendicular to the first plurality of photovoltaic cells 110. FIG. 5 illustrates a top view of a first plurality 510 of photovoltaic cells 110 and a second plurality 520 of photovoltaic cells at least partially embedded in a screen layer 120, wherein the second plurality 520 is disposed at least substantially normal to the surface plane 170 of the screen layer 120 and also disposed at least substantially perpendicular to the first plurality 510 of photovoltaic cells 110. Similar to the first plurality of photovoltaic cells 110, the second plurality of photovoltaic cells may be disposed in an array, parallel to one another, and/or at a constant pitch. In some embodiments, the second plurality and the first plurality of photovoltaic cells 110 may be at least partially embedded in the screen layer 120 at the same time. In addition, the second plurality and the first plurality may be disposed in the screen layer 120 in the desired orientation at the same time.

In some embodiments, the first and/or second plurality of photovoltaic cells 110 can be embedded in the screen layer 120 of the electronic device 130 and disposed at least substantially normal to a surface plane 170 of the screen layer 110 by creating inserts or slots in the screen layer 120. The inserts or slots can be created in the screen layer 120 by selectively removing material from the screen layer 120 by, for example, cutting, grinding, milling, or etching. The inserts or slots may be configured to receive the photovoltaic cells 110 in the desired orientation in the screen layer 120. In embodiments where slots are created into a pre-fabricated screen, the cell orientation will typically be known before the slots are cut. Accordingly, in such embodiments, one or both of the disposing steps 630 and 660 (wherein the cell orientation is established—e.g., the slots are disposed in the screen) will precede the embedding steps 620 and 650, during which the photovoltaic cells are embedded in slots that are already cut at the proper Orientation to accommodate the cells.

In some embodiments, the screen layer for an electronic device may be fabricated with the first and/or second plurality of photovoltaic cells at least partially embedded in it. Thus, in some embodiments, the screen layer may be fabricated around the photovoltaic cells and with the photovoltaic cells already in place. In these embodiments, the production method for the screen layer may be designed to avoid negatively affecting the composition and/or performance of the photovoltaic cells. This may involve, for example, controlling the temperature of the fabrication process. For example, the screen may be formed by cooling a molten material at a temperature sufficiently low to prevent damage to the photovoltaic cells. In sonic embodiments, the screen layer may be fabricated with photovoltaic cells at least partially embedded in it by casting a low-temperature thermoplastic around the solar cells. As another example, the screen layer may be fabricated with photovoltaic cells at least partially embedded in it by molding, or cold casting a curable thermosetting polymer resin into a screen around the photovoltaic cells. As another example, the screen layer may be fabricated with photovoltaic cells at least partially embedded in it by using additive manufacturing to create a polymer screen around the photovoltaic cells. Additive manufacturing can include 3D printing, stereolithography, and fused deposition modeling.

In some embodiments, a method of making a screen layer involves only the first plurality of photovoltaic cells and not the second plurality of photovoltaic cells. Thus, in some embodiments, a method of making a screen includes steps 610, 620, 630, and does not include steps 640, 650, 660, and 670.

In some embodiments, the thin film photovoltaic cells in the screen of the electronic device may be exposed to light while the electronic device is in use, thereby causing the thin film photovoltaic cells to produce electricity and causing the electronic interfaces to collect the electricity produced by the thin film photovoltaic cells. In some embodiments, the electronic interfaces may directly supply the electronic device with the electricity collected from the thin film photovoltaic cells. In some embodiments, the electronic interfaces may charge a battery of the electronic device with the electricity collected from the thin film photovoltaic cells.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

### EXAMPLE 1

### Making and Using an Intrascreen Array of Photovoltaic Cells for a Smartphone

A screen layer for a smartphone is provided. The screen layer is made of borosilicate glass and is 1 mm thick, 4.98 cm wide, and 8.86 cm long. An array of thin film photovoltaic cells (SolarFlex Technologies, Watkinsville, Ga., United States) is provided. The thin film photovoltaic cells include cadmium telluride as the p-type semiconductor, cadmium sulfide as the n-type semiconductor, polyethylene as the substrate material, indium tin oxide as the conductive oxide layer, and silver as the electrodes. The array of thin film photovoltaic cells is 5 μm thick, 49.8 mm wide, and 0.95 mm long. The conversion efficiency of the that film photovoltaic cells is approximately 7%.

The array of thin film photovoltaic cells is embedded within the screen layer of the smartphone. The photovoltaic cells are disposed normal to a surface plane of the screen layer. The photovoltaic cells are spaced 1 mm apart from each other. Thus, given that the length of the screen is 8.86 cm long, an array of 88 photovoltaic cells is distributed evenly along the length of the screen.

The amount of power received by the photovoltaic cells is estimated using equation (1) below:

Q=τₛαₛI_{c}A_{c} (1)

where τₛ is the transmittance of the screen material, αₛ is the absorbance of the photovoltaic cell material, I_{c} is the solar radiation incident on the photovoltaic cell, and is the total surface area of all the photovoltaic cells. Certain optical factors, such as refraction of the incoming light and scattering from imperfections in the screen, may impact the estimated power. The sun strikes the array of photovoltaic cells at an incident angle of 45°. Given the 45° incident angle and the 1 mm spacing between the photovoltaic cells, each photovoltaic cell does not cast a shadow on a neighboring photovoltaic cell. Therefore, the total surface area of the photovoltaic cells (A_{c}) is the number of photovoltaic cells multiplied by the surface area of each photovoltaic cell. Thus, the value of A_{c} is 4.16×10⁻³ m². The solar radiation incident on the photovoltaic cells (I_{c}) is 1000 W/m². The transmittance of the screen material (τₛ) is 0.9. The absorbance of the photovoltaic cell material (αₛ) is 0.9. Using equation (1) to estimate the amount of power received by the photovoltaic cells results in a value of 3.73 watts. With a conversion efficiency of 7%, the electrical power produced is 0.24 watts.

The electrical power produced by the photovoltaic cells is supplied to the battery of the mobile electronic device, via electronic interfaces. Given a typical smartphone battery with 1300 milliamp-hours of charge, for use at a rated voltage of approximately 3.7 volts, which converts to an energy storage capacity of 4.81 watt-hours for the battery, a power of 0.24 watts produced by the array recharges nearly 5% of the capacity of the battery over the course of an hour.

### EXAMPLE 2

### Making and Using an Intrascreen Photovoltaic Array for an eBook Reader

An e-book reader is provided. The dimensions of the e-book reader are 133 mm in length, 74.7 mm in width, and 1.0 mm in depth. The e-book reader also has a 3.7V, 1530 milliamp-.hours battery A plurality of photovoltaic cells is provided, with the properties described above with respect to Example 1.

The array of thin film photovoltaic cells are embedded within the screen layer. The photovoltaic cells are disposed normal to a surface plane of the screen layer. The photovoltaic cells are spaced 1 mm apart from each other. Thus, an array of 132 solar cells is distributed evenly along the length of the screen layer, given that the screen is 133 mm in length.

Using the light conditions described above with respect to Example 1, and using equation (1) to calculate the amount of power received by the photovoltaic cells, the amount of power received by the photovoltaic cells is 0.53 watts, which is over 9% of the capacity of the battery of the e-book reader for one hour. This recharge rate is faster than the rate at which the e-book reader drains energy from the battery. Thus, the photovoltaic array in the screen layer is capable of powering the e-book reader indefinitely.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent, is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C. etc.” is used, in general such a construction is intended in the sense one having skill in the art would understand the convention e.g., “a system having at least one of A, B, and C” would include but not be limited to systems that have A alone, B alone, C alone, A and B together, A and C together, Band C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. ‘thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A screen for an electronic device, the screen comprising:
a first array of thin film photovoltaic cells at least partially embedded in a screen layer, wherein the thin film photovoltaic cells are disposed at least substantially normal to a surface plane of the screen layer to capture light that is at least substantially off-normal to the surface plane of the screen layer.

2. The screen of claim 1, wherein the light comprises ambient light, and wherein the ambient light comprises solar spectrum of light, artificial light, or a combination thereof.

3. The screen of claim 1 wherein the light comprises diffused light emitted by the electronic device.

4. The screen of claim 1, wherein the thin film photovoltaic cells are disposed at a constant pitch in the screen layer.

5. The screen of claim 1, wherein the thin film photovoltaic cells are disposed parallel to one another in the screen layer.

6. The screen of claim 1, wherein in least one of the thin film photovoltaic cells has a thickness of about 100 nm to about 100 μm.

7. The screen of claim 1, wherein at least one of the thin film photovoltaic cells comprises amorphous silicon, gallium arsenide, copper indium gallium diselenide (CIGS), cadmium telluride, organic materials, dye-sensitized materials, poly(3- hexylthiophene), or a combination thereof.

8. The screen of claim 1, wherein each of the thin film photovoltaic cells comprise a light capturing side and a non-light capturing side, and the array of thin film photovoltaic cells comprises at least one pair of thin film photovoltaic cells having non-light capturing sides facing each other, and light-capturing sides facing away from the non-light capturing sides.

9. The screen of claim 1, wherein at least one of the thin film photovoltaic cells is transparent to visible light.

10. The screen of claim 9, wherein at least one of the thin film photovoltaic comprises glass, transparent polyethylene terephthalate, or a combination thereof.

11. The screen of claim 1, wherein at least one of the thin film photovoltaic cells comprise a pair electrodes, and wherein the electrodes comprise indium tin oxide, titanium-titanium oxide films, transparent patterned metal grids, eutectic gallium- indium, titanium, aluminum, gold, silver, platinum, copper, graphite, grapheme, reduced grapheme oxide, poly(3,4-ethylenedioxythiophene):poly(styrenesulfonate), polyacetylene, polyparaphenylene, polypyrrole, polyaniline, or a combination thereof.

12. The screen of claim 1, wherein at least one of the thin film photovoltaic arrays comprise a substrate, and wherein the substrate comprises metal foils, steel, polymers, polyethylene terephthalate, polyethylene sulphonate, polyethylene naphthalate, liquid crystal polymer, thermoplastic ethylene-tetracyclododecene copolymer, glass, borosilicate glass, soda-lime glass, or a combination thereof

13. The screen of claim 1, wherein at east one of the, thin film photovoltaic cells are configured to convert the light to electrical power and to supply the electrical power to electronic interfaces disposed between electrodes of the thin film photovoltaic cells and the electronic device.

16. The screen of claim 1, further comprising:
a second array of thin film photovoltaic cells at least partially embedded in the screen layer, wherein the thin film photovoltaic cells of the second array are disposed at least substantially normal to the surface plane of the screen layer to capture light that is substantially off-normal to the surface plane of the screen layer, and wherein the thin film photovoltaic cells of the second array are disposed at least substantially perpendicular to the thin film photovoltaic cells of the first array.

17. An electronic device, comprising
a screen layer;
a first array of thin film photovoltaic cells at least partially embedded in the screen layer, wherein the thin film photovoltaic cells are disposed at least substantially normal to a surface plane of the screen layer to capture light that is at least substantially off-normal to the surface plane of the screen layer; and
electronic, interfaces coupled to the thin film photovoltaic cells, wherein the electronic interfaces are configured to collect electricity produced by the thin film photovoltaic cells.

18. The electronic device of claim 17, wherein the screen is integrated with the electronic device.

19. The electronic device of claim 17, wherein the screen is detached from the electronic device and configured to connect to the electronic device.

20. The electronic device of claim 17, wherein the electronic interfaces comprise conductive metals, gold, silver, aluminum, platinum, copper, carbon-based conductors, graphite, graphene, conductive polymers, poly(3,4-ethylenedioxythiophene):poly(senesulfonate), polyacetylene, polyparaphenylene, polypyrrole, polyaniline, or a combination thereof.

21. The electronic device of claim 17, wherein the electronic interfaces are disposed beneath the thin film photovoltaic cells, beneath the screen, on one or more edges of the thin film photovoltaic cells, around a rim of the screen, or any combination thereof.

22. The electronic device of claim 17, wherein the electronic interfaces are configured to connect to a power supply of the electronic device.

23. The electronic device of claim 17, wherein the electronic interfaces are configured to supply the electronic device directly with the electricity collected from the thin film photovoltaic cells.

24. The electronic device of claim 17, wherein the electronic interfaces are configured to charge a battery of the electronic device with the electricity collected from the thin film photovoltaic cells.

25. (canceled)

26. A method to manufacture a screen for an electronic device, wherein the screen defines a surface plane, the method comprising:
positioning a first array of thin film photovoltaic cells relative to the surface plane, wherein at least some of the photovoltaic cells are positioned substantially normal to the surface plane, and wherein at least some of the photovoltaic cells are configured to capture light that is off-normal to the surface plane.

27.-28. (canceled)

29. The method of claim 26, further comprising embedding the first array of thin film photovoltaic cells within the screen in accordance with their positions relative to the surface plane.

30. The method of claim 29, wherein embedding comprises creating voids within the screen, the voids being configured to receive the thin film photovoltaic cells.

31. The method of claim 26, further comprising fabricating the screen around the first array of thin film photovoltaic cells.

32. The method of claim 26, further comprising:
providing a second plurality of thin film photovoltaic cells;
at least partially embedding the second plurality of thin film photovoltaic cells in the screen layer;
disposing the second plurality of thin film photovoltaic cells at least substantially normal to the surface plane of the screen to capture light that is at least substantially off-normal to the surface plane of the screen layer; and
disposing the second plurality of thin film photovoltaic cells at least substantially perpendicular to the first plurality of thin film photovoltaic cells.

33.-35. (canceled)
